(19) United States
(12) Patent Application Publication
(10) Pub. No.: US 2021/0363037 A1
(43) Pub. Date: Nov. 25, 2021

(54) METHOD OF TREATING WATER CONTAINING ARSENIC AND MANGANESE

(71) Applicant: The Corporation of the City of White Rock, White Rock (CA)

(72) Inventors: Saad JASIM, White Rock (CA); Madjid MOHSENI, Vancouver (CA)

(21) Appl. No.: 16/880,495

(22) Filed: May 21, 2020

(51) Int. Cl. C02F 1/78; C02F 1/00; C02F 1/64

(52) U.S. Cl. CPC C02F 1/78; C02F 2101/103; C02F 1/64; C02F 1/001

(57) ABSTRACT

A method of treating water containing arsenic and manganese. Ozone is injected into the water at a concentration in the range of 0.2 to 1.0 mg/L, oxidizing As(III) to As(V) and Mn(II) to Mn(IV). Ferric chloride coagulant is added to the ozonated water, coagulating the As(V) and the Mn(IV). The water is then filtered with a first filter medium selected for removal of the Mn(IV) followed by a second filter medium selected for removal of As(V). This removes the coagulate to produce treated water. The method removes arsenic and manganese to low levels acceptable for drinking water, using low concentrations of ozone as an oxidant. An advantage is that the ozone system can have a relatively small footprint, and use less energy, an important factor for climate change. Further, a quenching agent for removal of residual ozone is not required.

### FIELD OF THE INVENTION

The invention pertains to the purification of water, and in particular to the removal of arsenic and manganese from water intended to be used as drinking water.

### BACKGROUND OF THE INVENTION

Arsenic is a natural element that is present in Earth's crust. It is often found naturally in groundwater, through erosion and weathering of soils, minerals, and ores. Arsenic presence in the environment may come mainly via drinking water which can cause a serious threat to human health. Sources of drinking water are mainly from surface water or ground depending on the availability. Higher arsenic concentrations are usually present in groundwater.

Arsenic is one of the many chemicals for which Health Canada has set guidelines. The maximum concentration permitted in drinking water is 0.010 mg/L (10 μg/L).

The two predominant inorganic arsenic species found in drinking waters are arsenite As(III) and pentavalent arsenate As(V). As(III) is commonly associated with ground waters while As(V) is associated with both ground and surface waters. The efficiency of arsenic removal from a drinking water supply is dependent on the oxidation state of the arsenic because the removal technology is often based on ion exchange or iron co-precipitation. Arsenic present in groundwater as As(III), which is neutrally charged, needs to be oxidized to As(V), which is negatively charged, for optimum removal. The use of a strong oxidant is an important factor to achieve arsenic removal.

Manganese occurs naturally in the environment, and is widely distributed in air, water and soil. Manganese may be present in water in the environment from natural sources (rock and soil weathering) or as a result of human activities (such as mining, industrial discharges and landfill leaching). It is used in various industries, including in the steel industry, and in the manufacture of various products (e.g., fireworks, dry-cell batteries, fertilizers, fungicides and cosmetics and paints).

Manganese may also be added to water as an oxidizing agent (permanganate), or it may be present as an impurity in coagulants used in the treatment of drinking water.

The “Guidelines for Canadian Drinking Water Quality: Guideline Technical Document—Manganese” (May 2019), set the drinking water guideline for manganese at a maximum acceptable concentration (MAC) of 0.12 mg/L (120 Ng/L).

The presence of manganese in drinking water supplies may be objectionable for a number of reasons. At higher concentrations, manganese causes stains on laundry and leaves deposits on supply pipes in distribution system and in residential plumbing that may cause objectionable-tasting water. The presence of manganese in water may lead to the accumulation of microbial growths in the distribution system. Even at concentrations below 0.05 mg/L, manganese may form coatings on water distribution pipes that may slough off as black precipitates.

Concerns regarding the presence of manganese in drinking water are often related to consumer complaints about discoloured water. The current aesthetic objective (AO) of 0.02 mg/L (20 μg/L) is intended to minimize the occurrence of discoloured water complaints based on the presence of manganese oxides and to improve consumer confidence in drinking water quality.

In conventional water treatment processes, chlorine is commonly used as the pre-oxidant to oxidize arsenic, manganese and other contaminants. The application of ozone for water treatment processes can enhance the ability to remove many contaminants and reduce disinfectant by-products. Ozone, a strong oxidant, is more effective than chlorine in the oxidation of organic and inorganic compounds. However, to generate high concentrations of ozone, the ozone-generating system would require a high production capacity, resulting in a large ozone system, high costs and high energy consumption. There remains a need to have an effective water treatment method, capable of removing arsenic and manganese to acceptably low levels, in which low concentrations of ozone may be used to oxidize the arsenic and manganese.

### SUMMARY OF THE INVENTION

One aspect of the invention provides a method of treating water containing arsenic and manganese, comprising the steps of (a) adding ozone to the water at a concentration in the range of 0.2 to 1.0 mg/L and thereby oxidizing As(III) to As(V) and Mn(II) to Mn(IV); (b) adding an iron-based coagulant to the water after step (a) and thereby coagulating the As(V) and the Mn(IV) to form a coagulate; and (c) filtering the water after step (b) with a first filter medium for removal of the Mn(IV) and a second filter medium for removal of As(V), and thereby removing the coagulate to produce treated water.

In some embodiments, the ozone is added at a concentration in the range of 0.2 to less than 0.5 mg/L, or at a concentration in the range of 0.2 to 0.25 mg/L.

In some embodiments, the water to be treated further contains phosphate, and adding the iron-based coagulant to the water in step (b) also coagulates the phosphate, which is removed in step (c).

Further aspects of the invention and features of specific embodiments of the invention are described below.

### BRIEF DESCRIPTION OF THE DRAWINGS

FIG. 1 is a schematic diagram of a method of treating water according to one embodiment of the invention.

FIG. 2 is a schematic process follow diagram of a drinking water treatment plant according to an embodiment of the invention.

### DETAILED DESCRIPTION

The method of treating water containing inorganic arsenic and manganese according to one embodiment of the invention comprises the steps of adding ozone to the water and thereby oxidizing As(III) to As(V) and Mn(II) to Mn(IV), then adding iron-based coagulant to the water and thereby coagulating the As(V) and the Mn(IV) to form a coagulate, and then filtering the water with a first filter medium for removal of the Mn(IV) and a second filter medium for removal of As(V), and thereby removing the coagulate to produce treated water. The ozone may be added at a concentration in the range of 0.2 to 1.0 mg/L, alternatively in the range of 0.2 to less than 0.5 mg/L, alternatively in the range of 0.2 to 0.25 mg/L.

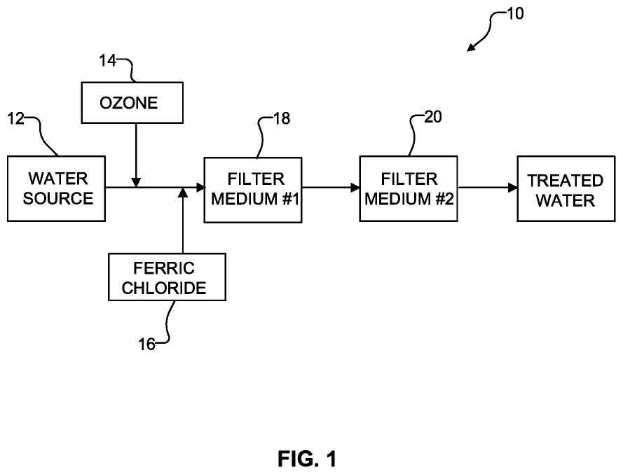

Referring to the schematic diagram of FIG. 1, the water treatment system 10 has a water source 12, an ozone system 14, a ferric chloride source 16, a first filter medium 18, and a second filter medium 20, to produce treated water 22.

The water source 12 comprises ground water or surface water or both, intended for drinking water, containing arsenic and manganese as contaminants. Typical levels of arsenic and manganese in the water 12 are 0.006-0.008 mg/L (6-8 μg/L) and 0.14-0.18 mg/L (140-180 μg/L), respectively.

In some embodiments, the water 12 also contains phosphates. Typical levels of phosphates are in the range of 0.15-0.2 mg/L.

The Ozone System

The ozone system 14 generates ozone to provide an ozone dose in the range of 0.2 to 1.00 mg/L, alternatively 0.2 to less than 0.5 mg/L, alternatively 0.2 to 0.25 mg/L, which is injected into the water. The ozone may be injected via side-stream injection, the concentrated ozonated water being injected into the raw water through an in-line mixer. An ozone system suitable for use in the invention is available from SUEZ Water Technologies & Solutions, Inc., USA. The ozone system may include two parallel trains of oxygen and ozone production with 100% redundancy, followed by two parallel 50% trains of ozone injection into two side streams of water pumped from a mainstream line. An ozone injection system suitable for use in the invention is available from Mazzei Injector Co., USA.

The side-stream ozone injection system may include injection booster pumps drawing raw water, venturi ejectors to draw ozone into the side-stream flow and static mixers to super-saturate the raw water with ozone. Prior to re-introduction of the side-stream flow into the ozone pipe reactor, any residual ozone gas may be collected using gas separation units and directing the ozone off-gas to thermal ozone destruct units.

A dissolved ozone monitor may be provided to measure dissolved ozone concentrations at one or more locations in the system. It is desirable that the downstream filter media 18, 20 not be exposed to high ozone concentrations.

The low concentration of ozone used in the practice of the invention has been determined to be advantageous. An important advantage is that the size of the ozone system can be substantially smaller and therefore less expensive, relative to a system for producing a higher concentration, such as above 1.0 mg/L. Oxidation of As(III) to As(V) was achieved at very low concentrations of ozone. Further, a quenching agent, such as calcium thiosulfate, for removal of residual ozone is not required.

Injection of Ferric Chloride

Downstream of the ozone injection, an iron-based coagulant, for example ferric chloride 16, is injected into the water to coagulate the oxidized arsenic and manganese. It has been determined that iron-based coagulants, including ferric chloride and ferric sulfate, are more effective at removing As(V) than their aluminum-based counterparts in the practice of the invention. This is because iron hydroxides are more stable than aluminum hydroxides in the pH range 5.5 to 8.5. It has also been determined that the use of ferric chloride extends the life of the filter media 18, 20 in the practice of the invention.

It is important that the ferric chloride be well mixed into the water prior to reaching the filters 18, 20. More than one point of injection of the ferric chloride into the ozone contactor pipe may be employed. The ferric chloride dosage may be about 1.2 mg/L, or in the range of 1.2-1.5 mg/L.

Filtration of Coagulated Manganese

Following the injection of ferric chloride, the water is passed through a first filter medium 18 which is selected for the effective removal of the oxidized manganese. For example, a manganese greensand filter medium may be used. One filter medium that is suitable in the practice of the invention is commercially available from AdEdge Water Technologies, USA, under the trademark Greensand Plus.

This has a manganese dioxide-coated surface that acts as a catalyst in the oxidation-reduction reaction of manganese, and a silica sand core.

In some embodiments, the filter medium 18 may be in two or more pressure filter vessels operating in parallel mode.

Filtration of Coagulated Arsenic

Downstream of the first filter medium 18, the water is passed through a second filter medium 20 which is selected for the effective removal of the oxidized arsenic. One filter medium 20 that is suitable in the practice of the invention is a granular ferric oxide medium commercially available from AdEdge Water Technologies under the trademark Bayoxide E33. It provides significant reduction of total arsenic, including both arsenic (III) and mainly arsenic (V), and is also effective in reducing other heavy metals such as lead, antimony and others.

In some embodiments, the second filter medium 20 may be in two or more pressure contactor vessels operating in parallel mode, for example four vessels.

In the method of the invention, it is desirable that the second filter medium 20 be downstream of the first filter medium 18. This is because the manganese should be removed before the water stream is passed to the second filter medium to avoid having the manganese deposited or adsorbed on the second filter medium, which would reduce its effective operation.

Following its filtration by filter medium 20, the treated water 22 may be subjected to chlorination or other treatments conventional to the preparation of water for drinking purposes. The level of arsenic in the treated water may be less than 0.005 mg/L. The level of manganese may be below detectible limits, e.g., less than 0.001 mg/L.

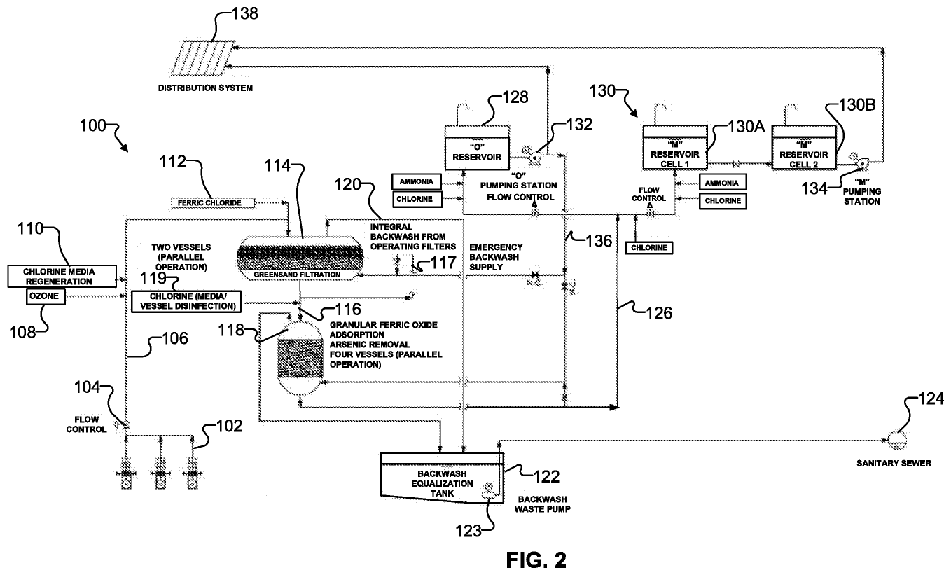

### Embodiment of FIG. 2

FIG. 2 is a schematic process flow diagram of a drinking water treatment plant 100 according to an embodiment of the invention. Water to be treated is fed into the system from wells 102. The well water, having naturally-occurring arsenic and manganese, passes a flow control valve 104 and into an ozone treatment contactor 106. An ozone system 108 feeds ozone by side-stream injection into the ozone treatment contactor 106. Downstream of the ozone injection points, a chlorine media regenerator 110 feeds into the ozone treatment contactor 106. Deposited manganese on the Greensand Plus filter medium is removed by oxidation with this addition of chlorine, which oxidizes and removes manganese and other deposits. The filter may also be taken out of service and soaked with chlorine for 1-2 hours

Further downstream from the ozone injection, a ferric chloride injection system 112 injects ferric chloride into the water flow in the ozone treatment contactor 106.

A manganese filtration system 114 receives the flow from the ozone treatment contactor downstream of the ferric injection system. It comprises two pressure filter vessels in parallel operation mode containing Greensand Plus filter medium.

Outflows from the manganese filtration system 114 are conduit 116 to the arsenic filtration system 118 and conduit 120 to the backwash equalization tank 122. The conduit 116 also feeds to an integral backwash 117 into the manganese filtration vessels. Chlorine 119 is fed into the conduit 116 for disinfection of the filter media when newly put into service.

The arsenic filtration system 118 comprises four pressure contactor vessels in parallel mode, containing Bayoxide E33 filter medium.

The backwash equalization tank 122 has inflows from the manganese filtration system 114 and the arsenic filtration system 118, and an outflow to a sanitary sewer 124. The backwash waste equalization tank 122 may be approximately 250 m³ and be located below the plant operating floor and accessible by floor hatches. Backwash waste from both the filters systems 114, 118 is directed to the tank 122 by gravity along with any non-sanitary waste streams, such as ozone generation cooling water and sample water streams. The backwash waste is disposed of to the municipal sanitary sewer system 124. Two submersible backwash waste pumps 123 are provided (one duty/one standby) to pump the backwash waste to the sanitary sewer. A full complement of filter backwashes is pumped to the sanitary sewer in an eight hour period. The pumps 123 may have a capacity of approximately 10 L/s. The pumps may be rail mounted to facilitate lifting them up for service.

The outflow of filtered water from the arsenic filtration system 118 passes through a conduit 126 and flow controllers to water reservoirs. In the present embodiment, the treatment system has a first reservoir “O” 128 and a second reservoir “M” 130, each having a pumping station 132, 134, respectively, and feeds for injecting chlorine and ammonia into the water. Reservoir ““M” 130 comprises two cells, 130A, 130B, to provide a high water storage capacity.

An emergency backwash supply is provided via conduit 136 from the pumping station 132 to both the manganese filtration system 114 and the arsenic filtration system 118. This backwash cleans the Greensand Plus and E33 filter media by dislodging accumulated contaminants, including manganese and arsenic, captured by the filter media. The resulting spent filter backwash contains particles trapped in the filters during the water treatment process.

Treated water in the reservoirs 128, 130 is pumped to a distribution system 138, for example, a municipal water distribution system.

### EXAMPLES

In the following controls and working examples 1 to 5, ozone was injected into the raw water. In the working examples, but not in the controls, ferric chloride was then injected. The water stream was filtered through a Greensand Plus filter medium and then through a Bayoxide E33 filter medium. The treatment system had four pressure contactor vessels for the Bayoxide filter medium, with a flow rate of 19.2 L/sec in each vessel.

Control examples #1, #2 and #3 were done without any addition of ferric chloride. In control example #1, 0.5 mg/L of ozone was used, and control examples #2 and #3 used 0.2 mg/L of ozone. The three control examples are outside the scope of the present invention.

Working examples #4 and #5 were done in accordance with the invention, using 0.22 mg/L of ozone and 1.45 mg/L of ferric chloride. The raw water contained 0.157 mg/L of phosphate before the injection of the ferric chloride and 0.1 mg/L after the injection.

The arsenic, manganese and pH data from Examples 1 to 5 are shown below in Table 1.

TABLE 1

| | | Arsenic | Manganese | |
|---|---|---|---|---|
| Example # | Raw/Treated | (mg/L) | (mg/L) | pH |
| 1 | Raw | 0.0072 | 0.013 | 7.83 |
| | Treated | 0.0026 | 0.030 | 8.06 |
| 2 | Raw | 0.0072 | 0.16 | 7.99 |
| | Treated | 0.0041 | <0.001 | 7.90 |
| 3 | Raw | 0.0070 | 0.099 | 7.45 |
| | Treated | 0.0041 | <0.005 | 7.86 |
| 4 | Raw | 0.0061 | 0.16 | 7.99 |
| | Treated | 0.0023 | <0.001 | 8.07 |
| 5 | Raw | 0.0064 | 0.15 | 8.15 |
| | Treated | 0.0023 | <0.001 | 8.17 |

It was observed that the treatment method of working examples #4 and #5 resulted in the lowest levels of arsenic and the combined lowest levels of arsenic and manganese.

### Examples 6 to 9

Samples of water containing both As(III) and As(V) were injected with ozone at various concentrations to assess the degree of oxidation of As(III) to As(V). The results are shown in Table 2.

| | Raw/ | Ozone | Arsenate As(V) | Arsenite As(III) |
|---|---|---|---|---|
| Example # | Treated | (mg/L) | μg/L | μg/L |
| 6 | Raw | | 5.48 | 0.950 |
| | Treated | 0.5 | 6.12 | <0.040 |
| 7 | Raw | | 5.75 | 0.213 |
| | Treated | 0.4 | 5.89 | <0.040 |
| 8 | Raw | | 6.81 | 0.218 |
| | Treated | 0.21 | 6.59 | <0.040 |
| 9 | Raw | | 6.55 | 0.295 |
| | Treated | 0.21 | 6.51 | <0.040 |

It was observed that low levels of ozone, in the range of 0.21 to 0.5 mg/L, were able to oxidize As(III) effectively.

As will be apparent to those skilled in the art in the light of the foregoing disclosure, many alterations and modifications are possible in the practice of this invention without departing from the scope thereof. Accordingly, the scope of the invention is to be construed in accordance with the following claims.

1. A method of treating water containing arsenic and manganese, comprising:
(a) adding ozone to the water at a concentration in the range of 0.2 to 1.0 mg/L and thereby oxidizing As(III) to As(V) and Mn(II) to Mn(IV);
(b) adding iron-based coagulant to the water after step (a) and thereby coagulating the As(V) and the Mn(IV) to form a coagulate; and
(c) filtering the water after step (b) with a first filter medium for removal of the Mn(IV) and a second filter medium for removal of As(V), and thereby removing the coagulate to produce treated water.

2. A method according to claim 1, wherein the ozone is added at a concentration in the range of 0.2 to less than 0.5 mg/L.

3. A method according to claim 1, wherein the ozone is added at a concentration in the range of 0.2 to 0.25 mg/L.

4. A method according to claim 1, wherein the iron-based coagulant is ferric chloride.

5. A method according to claim 4, wherein the ferric chloride is added at a concentration of 1.2 mg/L or higher.

6. A method according to claim 4, wherein the ferric chloride is added at a concentration in the range of 1.2 to 1.45 mg/L.

7. A method according to claim 1, wherein the first filter medium comprises manganese dioxide.

8. A method according to claim 1, wherein the first filter medium comprises manganese dioxide-coated silica sand.

9. A method according to claim 1, wherein the second filter media comprises ferric oxide.

10. A method according to claim 1, wherein, in step (c), the second filter medium is downstream of the first filter medium.

11. A method according to claim 1, wherein the water further contains phosphate, and adding ferric chloride to the water in step (b) also coagulates the phosphate, such that the coagulate further comprises phosphate, which is removed in step (c).

12. A method according to claim 1, wherein the water before treatment contains arsenic in the range of 0.006-0.008 mg/L and manganese in the range of 0.14 to 0.18 mg/L.

13. A method according to claim 1, wherein the treated water comprises less than 0.005 mg/L of arsenic.

14. A method according to claim 1, wherein the treated water comprises less than 0.003 mg/L of arsenic.

15. A method according to claim 1, wherein the treated water comprises less than 0.005 mg/L of manganese.

16. A method according to claim 1, wherein the treated water comprises less than 0.15 mg/L of phosphate.

17. A method of treating water containing arsenic and manganese, comprising:
(a) adding ozone to the water at a concentration in the range of 0.2 to 1.0 mg/L and thereby oxidizing As(III) to As(V) and Mn(II) to Mn(IV);
(b) adding iron-based coagulant to the water after step (a) and thereby coagulating the As(V) and the Mn(IV) to form a coagulate;
(c) filtering the water after step (b) with a first filter medium for removal of the Mn(IV); and
(d) filtering the water after step (c) with a second filter medium for removal of As(V), to produce treated water.

18. A method according to claim 17, wherein the ozone is added at a concentration in the range of 0.2 to less than 0.5 mg/L.

19. A method according to claim 17, wherein the ozone is added at a concentration in the range of 0.2 to 0.25 mg/L.
